(19) United States
(12) Patent Application Publication
(10) Pub. No.: US 2005/0149913 A1
(43) Pub. Date: Jul. 7, 2005

(54) Apparatus and methods to optimize code in view of masking status of exceptions

(76) Inventors: Yun Wang, Shanghai (CN); Orna Etzion, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/745,642

(22) Filed: Dec. 29, 2003

(51) Int. Cl. G06F 9/45

(52) U.S. Cl. 717/136

(57) ABSTRACT

A source binary code that complies with a source architecture is translated to a target binary code that complies with a target architecture. The target binary code includes a first target portion translated from a respective source portion of the source binary code. During execution of the target binary code on a processor that complies with a target architecture, it is determined whether to retranslate the source portion to produce a second target portion that is more optimized to the target architecture than the first target portion or to retranslate the source portion to produce a third target portion that is more optimized to the target architecture than the second target portion.

### BACKGROUND OF THE INVENTION

Translation software may be used to translate source binary code, written for a first processor architecture having a first instruction set, to target binary code that complies with a second processor architecture having a second instruction set. The target binary code may then be executed on any processor that complies with the second processor architecture.

During translation, one or more portions of the source binary code may be optimized to better suit the second processor architecture. The source binary code may handle exceptions. The optimization may result in the target binary code handling exceptions improperly or in a different way than they are handled in the source binary code.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an exemplary apparatus according to some embodiments of the invention; and

FIGS. 2, 3 and 4 are a flowchart illustration of an exemplary method to be implemented in a dynamic translator for translating a portion of a source binary code into a portion of a target binary code, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods and procedures have not been described in detail so as not to obscure the embodiments of the invention.

Some portions of the detailed description which follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. It will be appreciated that a variety of programming languages may be used to implement the teachings of the invention as described herein.

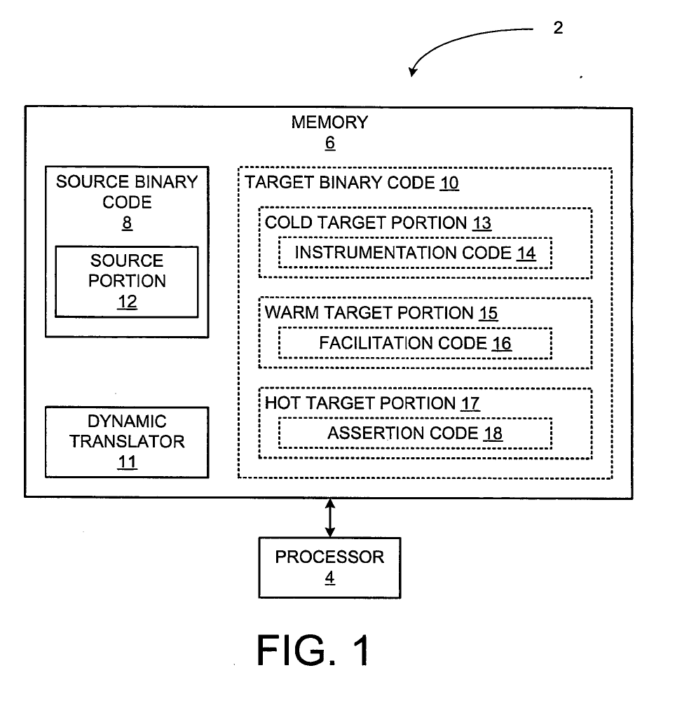

FIG. 1 is a block diagram of an exemplary apparatus 2 according to some embodiments of the invention. Apparatus 2 may include a processor 4 and a memory 6 coupled to processor 4.

A non-exhaustive list of examples for apparatus 2 includes a desktop personal computer, a work station, a server computer, a laptop computer, a notebook computer, a hand-held computer, a personal digital assistant (PDA), a mobile telephone, a game console, and the like.

A non-exhaustive list of examples for processor 4 includes a central processing unit (CPU), a digital signal processor (DSP), a reduced instruction set computer (RISC), a complex instruction set computer (CISC) and the like. Moreover, processor 4 may be part of an application specific integrated circuit (ASIC) or may be a part of an application specific standard product (ASSP).

Memory 6 may be fixed in or removable from apparatus 2. A non-exhaustive list of examples for memory 6 includes one or any combination of the following:

semiconductor devices, such as
synchronous dynamic random access memory (SDRAM) devices, RAMBUS dynamic random access memory (RDRAM) devices, double data rate (DDR) memory devices, static random access memory (SRAM), flash memory devices, electrically erasable programmable read only memory devices (EEPROM), non-volatile random access memory devices (NVRAM), universal serial bus (USB) removable memory, and the like,

optical devices, such as
compact disk read only memory (CD ROM), and the like,

and magnetic devices, such as
a hard disk, a floppy disk, a magnetic tape, and the like.

Processor 4 may have an instruction set that complies with a “target” architecture. A non-limiting example for the target architecture is the Intel™ architecture-64 (IA-64). Memory 6 may store a source binary code 8 that complies with a “source” architecture. A non-limiting example for the source architecture is the Intel™ architecture-32 (IA-32). If the source architecture does not comply with the target architecture, as is the case, for example, with the IA-32 and IA-64 architectures, processor 4 may not be able to execute source binary code 8.

A dynamic translator 11, stored in memory 6 or elsewhere, may receive source binary code 8 as an input and may generate a target binary code 10 that complies with the target architecture. Target binary code 10 may be stored in memory 6 or elsewhere and may be executed by processor 4. The results produced by executing target binary code 10 on processor 4 may be substantially the same as those produced by executing source binary code 8 on a processor that complies with the source architecture.

Dynamic translator 11 may translate the entirety of source binary code 8 into target binary code 10 as a whole. Alternatively, dynamic translator 11 may translate individual portions of source binary code 8 into respective portions of target binary code 10.

A portion of source binary code 8 may be translated into one of at least three exemplary types of target binary code portions: “cold”, “warm” and “hot”. A warm target portion may require more translation time than a cold target portion but less translation time than a hot target portion. The optimization of a warm target portion to the target architecture may be more than that of a cold target portion and less than that of a hot target portion.

In a cold target portion, the order of instructions may be the same as in the source portion, and the canonical states of the source portion may be preserved. A cold target portion may handle exceptions in substantially the same way as the source portion from which it was translated. In a hot target portion, the order of instructions may differ from the order of instructions in the source portion, and the canonical states of the source portion may not be preserved.

Although the invention is not limited in this respect, dynamic translator 11 may use pre-stored templates to replace instructions of source portions with translated instructions of cold target portions.

A warm target portion may be optimized under the assumption that one or more specific exceptions, such as, for example, floating point exceptions, might not be masked during execution of the warm target portion. For example, the IA-32 and IA-64 architectures both support the following specific exceptions: “invalid operation”, “division by zero”, “overflow”, “underflow” and “inexact calculation” floating point exceptions, as defined and required in the ANSI/IEEE standard 754-1985 for binary floating-point arithmetic, and a “denormal operand” floating point exception.

In contrast, a hot target portion may be optimized under the assumption that the specific exceptions are masked during execution of the hot target portion. An assertion code may check the masking status of the specific exceptions before the hot target portion is executed. If all of the specific exceptions are masked, the hot target portion may be executed. However, if at least one of the specific exceptions is not masked, the hot target portion may not be executed, and instead, the target binary code may branch to execute a respective cold target portion or a respective “warm” target portion that may fulfill substantially the same functionality as the hot target portion. Although the invention is not limited in this respect, the assertion code may be embedded in the hot target portion. Alternatively, the assertion code may be embedded elsewhere in target binary code 10.

In the translation of a source portion into a hot target portion, the optimizations used may change the order of the exceptions and/or may cause exceptions to be raised and handled at the wrong time, and/or may cause the context of the exception to be overwritten before the exception is handled. According to some embodiments of the invention, such optimizations may not be used in the translation of a source portion into a warm target portion.

For example, if an unmasked floating point exception occurs during execution of floating point normalization code, it is expected that the exception will be raised and handled immediately in both the IA-32 architecture and the IA-64 architecture. Translation of a source code portion including floating point normalization code into a hot target portion may result in the exception being handled improperly by the hot target portion due to the results of the optimization. In contrast, translation of a source code portion including floating point normalization code into a warm target portion may exclude optimizations that result in improper handling of unmasked exceptions.

In another example, if a source portion that complies with the IA-32 architecture is translated to a hot target portion that complies with the IA-64 architecture, the hot target portion may include “commit-points”, in which states of the source portions can be recovered if required. The number of instructions between two commit-points may be determined so the code is optimally scheduled. However, if that source portion is translated into a warm target portion that complies with the IA-64 architecture, the number of instructions between two commit-points may be lower than in the hot target portion in order to ensure recovery of canonical states in the event of exceptions. As a result, the optimization of the warm target portion with respect to scheduling may be less than in the hot target portion.

In yet another example, if a source portion, that complies with the IA-32 architecture and includes streaming SIMD extensions (SSE) floating point instructions, is translated to a warm target portion that complies with the IA-64 architecture, conversion between canonical registers in the warm target portion may be performed through a temporary register, so if an exception occurs during the conversion, the value of the canonical register can be recovered from the temporary register. However, if the source portion is translated into a hot target portion that complies with the IA-64 architecture, conversion between canonical registers in the hot target portion may be performed directly from one canonical register to another. If an exception occurs during the conversion, the value of the canonical register may not be recoverable.

In a yet further example, a specific instruction of the IA-64 architecture may be used to generate floating point exceptions if an exception-raising situation occurs in a previous floating point instruction. In a hot target portion, this specific instruction may be located any number of instructions after the previous floating point instruction since the exceptions are masked. However, in a warm target portion, the specific instruction may need to be located immediately after the previous floating point instruction.

According to some embodiments of the invention, facilitation code may be added to a warm target portion to enable some optimization during the translation of a source portion into the warm target portion. For example, the facilitation code may help the recovery of canonical states and/or contexts if those canonical states and/or contexts are overwritten by an exception.

For example, a floating point addition instruction (1) may be executed to add the content of a register “c” to the content of a register “b”, and to store the result in a destination register “a”.
(1) fadd a=b, c

During the execution of instruction (1), an overflow may occur, and as a result, the value of register “a” may become invalid and if the overflow exception is not masked, it may be raised.

In a warm target portion, a facilitation instruction (2) may be included before instruction (1) to backup the value stored in register “a” to a register “backup_a” before instruction (1) is executed. In the event of an overflow exception being raised, the value of register “a” can be recovered from register “backup_a”.
(2) fmov backup_a=a
(1) fadd a=b, c

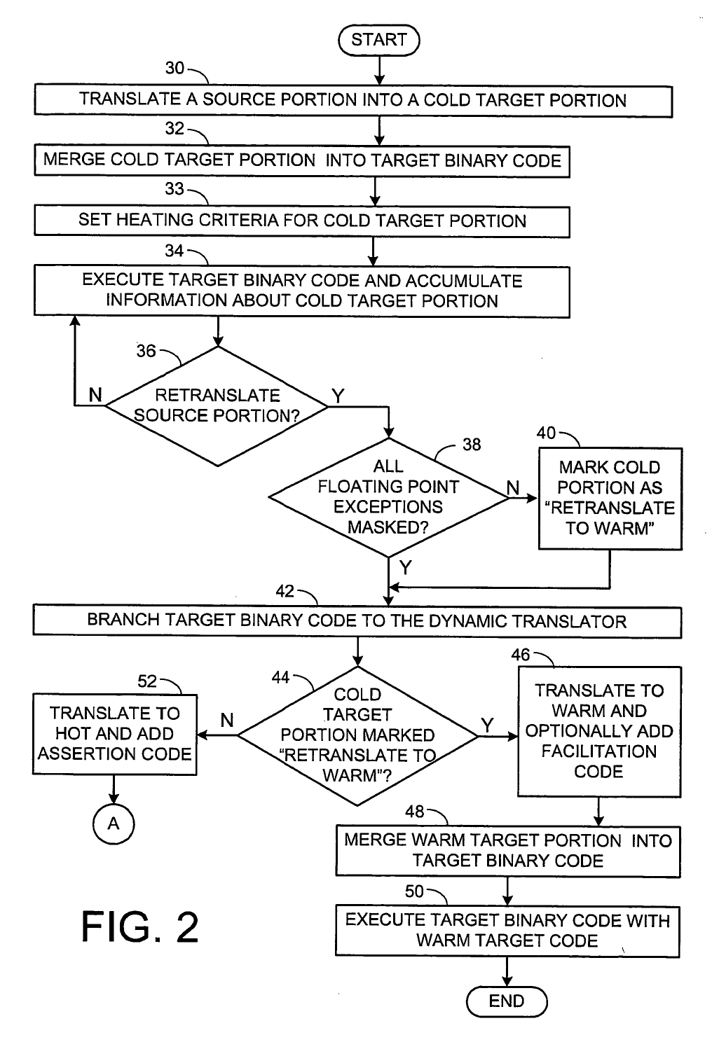

FIGS. 2, 3 and 4 are a flowchart illustration of an exemplary method for selecting the optimization level of a target code portion to be executed as part of a target binary code, according to some embodiments of the invention.

Referring to FIG. 2, dynamic translator 11 may translate source portion 12 into a cold target portion 13 (-30-) and may embed instrumentation code 14 in cold target portion 13. Cold target portion 13 may be merged with target binary code 10 (-32-), and one or more “heating criteria” may be set for cold target portion 13 (-33-). The heating criteria will determine one or more conditions for translating source portion 12 into a warm or hot target portion, for example, the number of times cold target portion 13 is executed, or the frequency with which cold target portion 13 is executed.

Processor 4 may execute target binary code 10 (-34-), and during the execution of target binary code 10 by processor 4, instrumentation code 14 may accumulate information to be checked against the heating criteria. As long as the heating criteria are not met (-36-), the method may continue with continued execution of target binary code 10 (-34-). However, if the heating criteria are met, the method may translate source portion 12 into a warm or hot target portion, as described hereinbelow.

If according to the information, or according to some other criteria, it is not desired to retranslate source portion 12 (-36-), the method may continue to execute target binary code 10 (-34-). However, if it is desired to retranslate source portion 12, the masking status of the specific exceptions (e.g. floating point exceptions) in target binary code 10 may be checked (-38-), and if at least one of the specific exceptions is not masked, cold target portion 13 may be marked as “retranslate to warm” (-40-).

Target binary code 10 may then branch to dynamic translator 11 (-42-). If cold target portion 13 is marked “retranslate to warm” (-44-), dynamic translator 11 may translate source portion 12 into a warm target portion 15 (-46-) and may optionally include facilitation code 16 in warm target portion 15. Warm target portion 15 may be merged into target binary code 10 (-48-). Processor 4 may execute target binary code 10 with warm target portion 15 included (-50-), and the method may be terminated.

However, if cold target portion 13 is not marked “retranslate to warm” (-44-), dynamic translator 11 may translate source portion 12 into a hot target portion 17 (-52-), and may include an assertion code 18 in hot target portion 17.

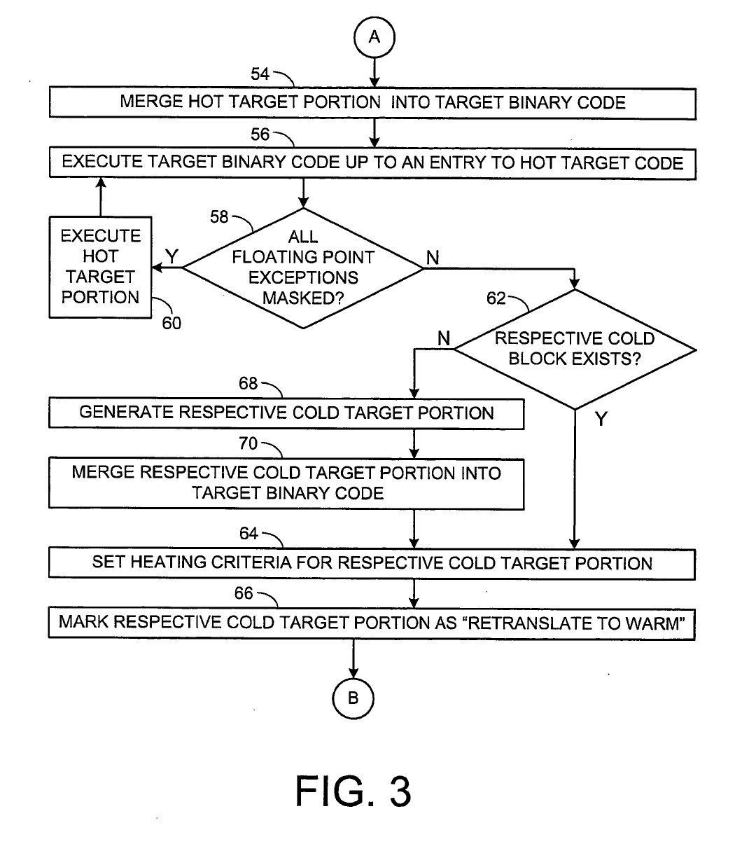

Referring now to FIG. 3, hot target portion 17 may be merged into target binary code 10 (-54-), and processor 4 may execute target binary code 10 up to an entry point to hot target portion 17 (-56-). At the beginning of execution of hot target portion 17, assertion code 18 may check the masking status of the specific exceptions in target binary code 10 (-58-). If all the specific exceptions are masked, hot target portion 17 may be executed (-60-), and the method may continue with continued execution of target binary code 10 up to an entry point to an additional hot target portion, if any (-56-).

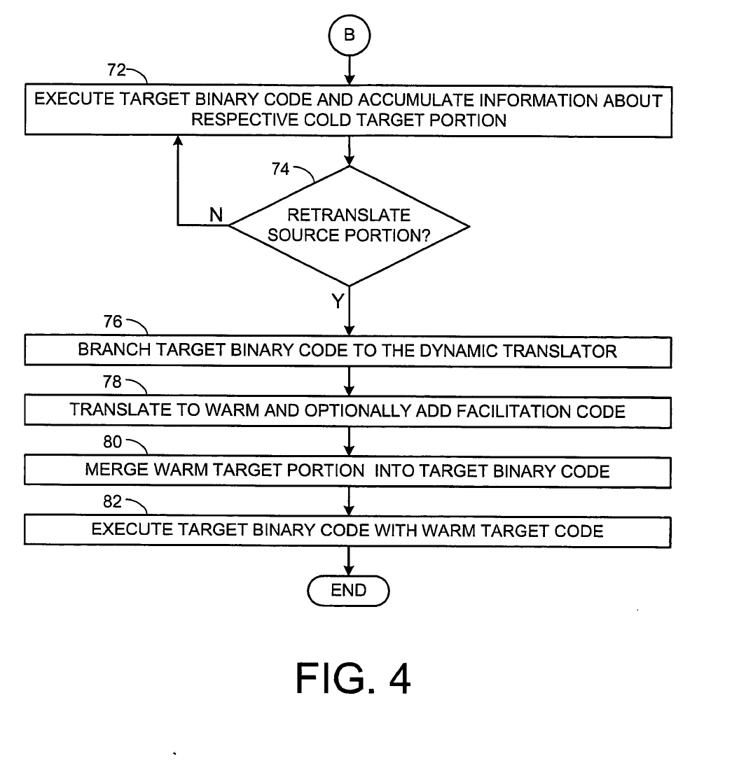

However, if at least one of the specific exceptions is not masked, the method may substitute a respective cold target portion for hot target portion 17 in target binary code 10. If such a respective cold portion already exists (-62-), the method may set a heating criteria for the respective cold portion (-64-) and may mark the respective cold portion as “retranslate to warm” (-66-). The method may then continue to block -72- in FIG. 4.

If a respective cold target portion does not exist, dynamic translator 11 may generate a respective cold portion (e.g. cold target portion 13) and may embed an instrumentation code (e.g. instrumentation code 14) in the respective cold target portion (-68-). The respective cold target portion may be merged into target binary code 10 (-70-), and the method may then continue to set a heating criteria for the respective cold portion (-64-).

According to some embodiments of the invention, in block -64-, the heating criteria may be set so it is never be met, and as a result the source portion may not be retranslated into a warm target portion. According to some other embodiments of the invention, in block -64-, the heating criteria may be set so it may be met, and as a result the respective cold portion will be replaced with a warm target portion.

Referring now to FIG. 4, processor 4 may execute target binary code 10 (-72-), and during the execution of target binary code 10 by processor 4, the instrumentation code 14 may accumulate information to be checked against the heating criteria. As long as the heating criteria of the respective cold target portion are not met (-74-), the method may continue with continued execution of target binary code 10 (-72-). However, if the heating criteria are met, target binary code 10 may branch to dynamic translator 11 (-76-). Dynamic translator 11 may translate source portion 12 into a respective warm target portion (e.g. warm target portion 15) (-78-) and may optionally include a facilitation code (e.g. facilitation code 16) in the respective warm target portion. The respective warm target portion may be merged into target binary code 10 (-80-), and processor 4 may execute target binary code 10 with the respective warm target portion included (-82-). The method may then be terminated.

In some embodiments of the invention, retranslation of a source portion into a warm target portion or a hot target portion may be performed by translation and optimization of consecutive source portions as a whole.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method comprising:
during execution of a target binary code on a processor that complies with a target architecture, the target binary code including a first target portion translated from a respective source portion of a source binary code that complies with a source architecture, determining whether to retranslate the source portion to produce a second target portion that is more optimized to the target architecture than the first target portion or to retranslate the source portion to produce a third target portion that is more optimized to the target architecture than the second target portion.

2. The method of claim 1, wherein determining to retranslate the source portion to produce the second target portion includes:
identifying that at least one of a predetermined group of exceptions is not masked.

3. The method of claim 1, further comprising:
retranslating the source portion to produce the second target portion;
substituting the second target portion for the first target portion in the target binary code; and
continuing execution of the target binary code.

4. The method of claim 3, wherein retranslating the source portion to produce the second target portion includes at least:
translating handling of an unmasked exception in the source portion to handling of the unmasked exception in the second target portion in substantially the same way as the source portion handles the unmasked exception during execution of the source portion on a processor that complies with the source architecture.

5. The method of claim 3, wherein retranslating the source portion to produce the second target portion includes at least:
optimizing the second target portion to the target architecture while excluding optimizations that result in improper handling of unmasked exceptions.

6. The method of claim 3, wherein retranslating the source portion to produce the second target portion includes at least:
including facilitation code in the second target portion.

7. The method of claim 1, further comprising:
retranslating the source portion to produce the third target portion;
substituting the third target portion for the first target portion in the target binary code;
continuing execution of the target binary code up to an entry into the third target portion;
if at least one of a predetermined group of exceptions is not masked:
substituting the first target portion for the third target portion in the target binary code;
executing the first target portion; and
determining whether to retranslate the source portion to produce a fourth target portion that is more optimized to the target architecture than the first target portion and is less optimized to the target architecture than the third target portion.

8. An article comprising a storage medium having stored thereon instructions that, when executed by a computing platform including a processor that complies with a target architecture, result in:
translating a source binary code that complies with a source architecture into a target binary code that complies with the target architecture, the target binary code including a first target portion translated from a respective source portion of the source binary code, the target binary code also including branching code to access the instructions; and
upon being accessed by the branching code during execution of the target binary code, determining whether to retranslate the source portion to produce a second target portion that is more optimized to the target architecture than the first target portion or to retranslate the source portion to produce a third target portion that is more optimized to the target architecture than the second target portion.

9. The article of claim 8, wherein determining to retranslate the source portion to produce the second target portion includes:
identifying that at least one of a predetermined group of exceptions is not masked.

10. The article of claim 8, wherein executing the instructions further results in:
retranslating the source portion to produce the second target portion;
substituting the second target portion for the first target portion in the target binary code; and
continuing execution of the target binary code.

11. The article of claim 10, wherein retranslating the source portion to produce the second target portion includes at least:
translating handling of an unmasked exception in the respective portion of said source binary code to handling of the unmasked exception in the second target portion in substantially the same way as the source portion handles the unmasked exception during execution of the source portion on a processor that complies with the source architecture.

12. The article of claim 10, wherein retranslating the source portion to produce the second target portion includes at least:
optimizing the second target portion to the target architecture while excluding optimizations that result in improper handling of unmasked exceptions.

13. The article of claim 10, wherein retranslating the source portion to produce the second target portion includes at least:
including facilitation code in the second target portion.

14. The article of claim 8, wherein executing said instructions further results in:
retranslating the source portion to produce the third target portion;
substituting the third target portion for the first target portion in the target binary code;
continuing execution of the target binary code up to an entry into the third target portion;
if at least one of a predetermined group of exceptions is not masked:
substituting the first target portion for the third target portion in the target binary code;
executing the first target portion; and
determining whether to retranslate the source portion to produce a fourth target portion that is more optimized to the target architecture than the first target portion and is less optimized to the target architecture than the third target portion.

15. An apparatus comprising:
a memory to store source binary code that complies with a source architecture; and
a processor that complies with a target architecture to execute target binary code that complies with the target architecture, the target binary code including a first target portion translated from a respective source portion of the source binary code, and to determine whether to retranslate the source portion to produce a second target portion that is more optimized to the target architecture than the first target portion or to retranslate the source portion to produce a third target portion that is more optimized to the target architecture than the second target portion.

16. The apparatus of claim 15, wherein the processor is to identify that at least one of a predetermined group of exceptions is not masked prior to determining to retranslate the source portion to produce the second target portion.

17. The apparatus of claim 15, wherein the processor is to retranslate the source portion to produce the second target portion, to substitute the second target portion for the first target portion in the target binary code, and to continue execution of the target binary code.

18. The apparatus of claim 17, wherein the processor is to translate handling of an unmasked exception in the respective portion of said source binary code to handling of the unmasked exception in the second target portion in substantially the same way as the source portion handles the unmasked exception during execution of the source portion on a processor that complies with the source architecture.

19. The apparatus of claim 17, wherein the processor is to optimize the second target portion to the target architecture while excluding optimizations that result in improper handling of unmasked exceptions.

20. The apparatus of claim 17, wherein the processor is to include facilitation code in the second target portion.

21. The apparatus of claim 17, wherein the processor is to retranslate the source portion to produce the third target portion, to substitute the third target portion for the first target portion in the target binary code, to continue execution of the target binary code up to the entry of the third target portion, and if at the entry, at least one of a predetermined group of exceptions is not masked, to a) substitute the first target portion for the third target portion in the target binary code, b) execute the first target portion, and c) determine whether to retranslate the source portion to produce a fourth target portion that is more optimized to the target architecture than the first target portion and is less optimized to the target architecture than the third target portion.
